(19) United States
(12) Patent Application Publication
(10) Pub. No.: US 2016/0253952 A1
(43) Pub. Date: Sep. 1, 2016

(54) FOLED DISPLAY CAP

(71) Applicants: Jack Donald Cox, Oakland, CA (US); Aaron Russell Cox, Oakland, CA (US)

(72) Inventors: Jack Donald Cox, Oakland, CA (US); Aaron Russell Cox, Oakland, CA (US)

(21) Appl. No.: 14/633,139

(22) Filed: Feb. 27, 2015

(51) Int. Cl. G09G 3/32; G06F 1/16; G06F 3/02; G06F 1/18

(52) U.S. Cl. CPC G09G 3/3208; G06F 1/188; G06F 1/163; G06F 1/1652; G06F 1/1684; G06F 3/02; G09G 2380/02; G09G 2330/02

(57) ABSTRACT

A foled (flexible organic light emitting diode) display cap is disclosed. The foled display cap provides a wearable hat comprising an integrated housing for attaching and operating a miniaturized foled video screen. The integrated housing further includes a software module having a memory module and a plurality of buttons for controlling images which are visible on its screen. In use, a wearer of the cap may input through use of the buttons digital representations of video, images, or text and store these digital representations into the memory module for use by the software module through a USB input port within the integrated housing. An electrical power source which may be by way of example a thin film polymer rechargeable battery is also located within the integrated housing for supplying electrical power to the miniaturized foled video screen and software/memory module while also providing a means for recharging the battery. The wearer then selects their digital representations of choice to be shown on the miniaturized foled video screen by pressing the buttons located on the integrated housing while wearing the cap for viewing by third parties.

### BACKGROUND OF THE INVENTION

1. Field of the Invention

The invention pertains to the field of entertainment. More specifically, this invention relates generally to a cap or hat having mounted on its exterior an integrated miniaturized flexible organic LED display such that the wearer of the cap or hat may display video, images or text to their surrounding area.

2. Summary of the Prior Art

It is well known in the art of personal attire to wear caps or hats for both physical comfort, such as providing warmth when the weather is cold or shade during the summer and spring seasons , as well as a means of personal self-expression such as sporting or musical events, or city names and the like. In the past, these forms of self-expression were static graphic or texts displaying a sport team's logo or the name of a scenic spot, entertainment attraction or a musical group mounted on the exterior of the hat for others to see.

Recently there have been attempts to provide dynamic as opposed to static graph or text display. These previous attempts have suffered from the inability to easily customize the appearance of the cap or hat when worn by the user. At best, these types of caps or hats employ a series of light emitters such as LEDs wherein a user may only adjust the intensity or frequency for a given pattern in which the LEDs are sequenced and are typically quite crude in appearance. Additionally, these caps or hats offering sequenced graphics or text messaging have the drawback wherein such sequencing typically requires several seconds of physical effort at a minimum from the user. Therefore, static, passive graphics mounted on caps or hats may be replaced by illuminated electronic displays wherein such displays may utilize technical solutions such as light emitting diodes when their display drive electronics and form and fit factor become more advanced through development for this type of technology.

The present invention solves the problem identified above by providing new type of recently developed flexible OLED which is miniaturized into a screen for mounting on a cap or hat for dynamically displaying video, images or text when worn by a user.

### SUMMARY OF THE INVENTION

A foled (flexible organic light emitting diode) display cap is disclosed. The foled display cap provides a wearable hat comprising an integrated housing for attaching and operating a miniaturized foled video screen. The integrated housing further includes a software module having a memory module and a plurality of buttons for controlling images which are visible on its screen. In use, a wearer of the cap may input through use of the buttons digital representations of video, images, or text and store these digital representations into the memory module for use by the software module through a USB input port within the integrated housing. An electrical power source which may be by way of example a thin film polymer rechargeable battery is also located within the integrated housing for supplying electrical power to the miniaturized foled video screen and software/memory module while also providing a means for recharging the battery. The wearer then selects their digital representations of choice to be shown on the miniaturized foled video screen by pressing the buttons located on the integrated housing while wearing the cap for viewing by third parties.

### BRIEF DESCRIPTION OF THE DRAWINGS

Further objects and advantages of the present invention will become apparent as the following description of the illustrative embodiments takes place, in which:

FIG. 1 is a drawing of a front perspective view illustrating the foled display cap in use in accordance with the present invention;

FIG. 2 is a drawing of a side elevational view illustrating the foled display cap shown in FIG. 1;

FIG. 3 is a drawing of a top exterior view of the foled display cap; and

FIG. 4 is a drawing of a bottom interior view of the foled display cap.

### DESCRIPTION OF A PREFERRED EMBODIMENT

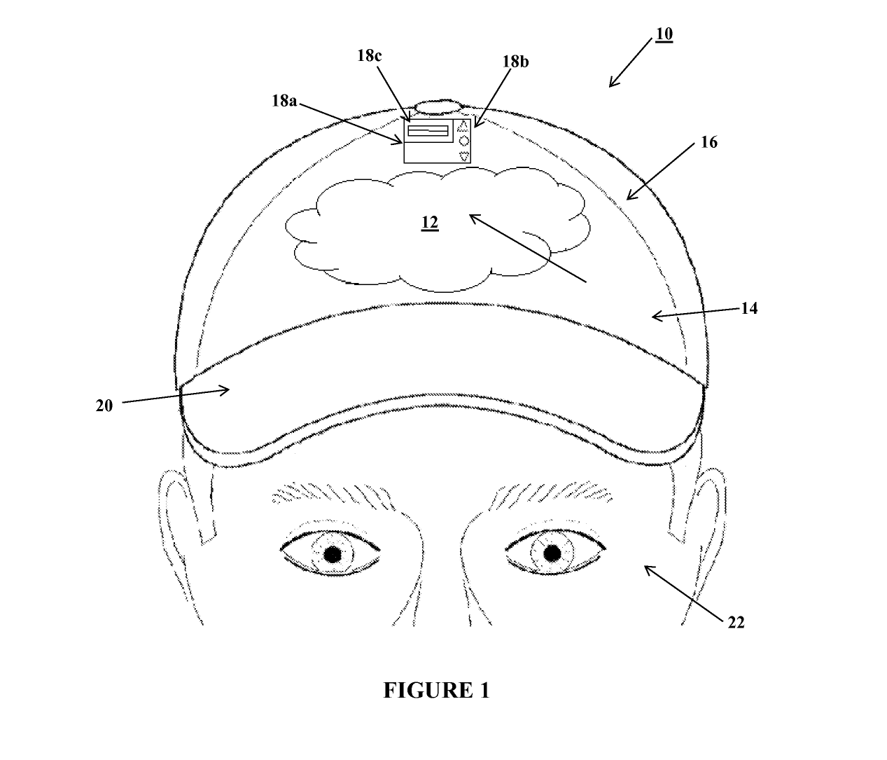

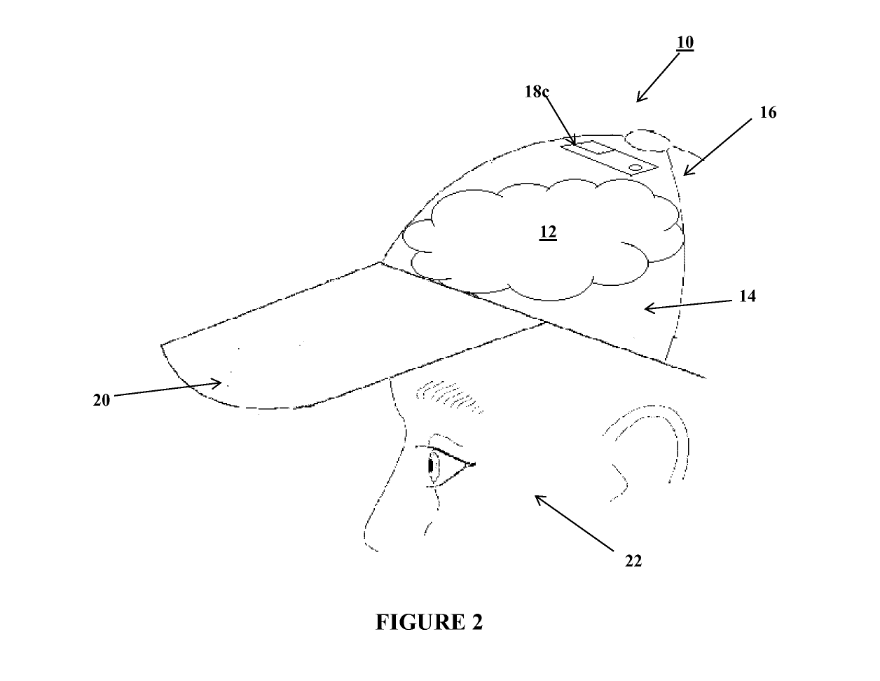

Referring now to FIGS. 1 and 2, there is shown a foled (flexible organic light emitting diode) display cap 10 in accordance with the present invention. The foled display cap 10 provides a wearable hat 16 comprising an integrated housing 12a for attaching and operating a miniaturized foled video screen 12 to the front of the panel 14 of the cap 16 centrally located above the cap's bill 20. The integrated housing 12a further includes a software module (not shown) having a memory module (not shown) and a plurality of buttons 18b for controlling images which are visible on its screen 12. In use, a wearer 22 of the cap 16 may input through use of the buttons 18b digital representations 18c of video, images, or text and store these digital representations into the memory module for use by the software module (not shown) through a USB input connection port 18a within the integrated housing 12a, as shown in FIG. 1.

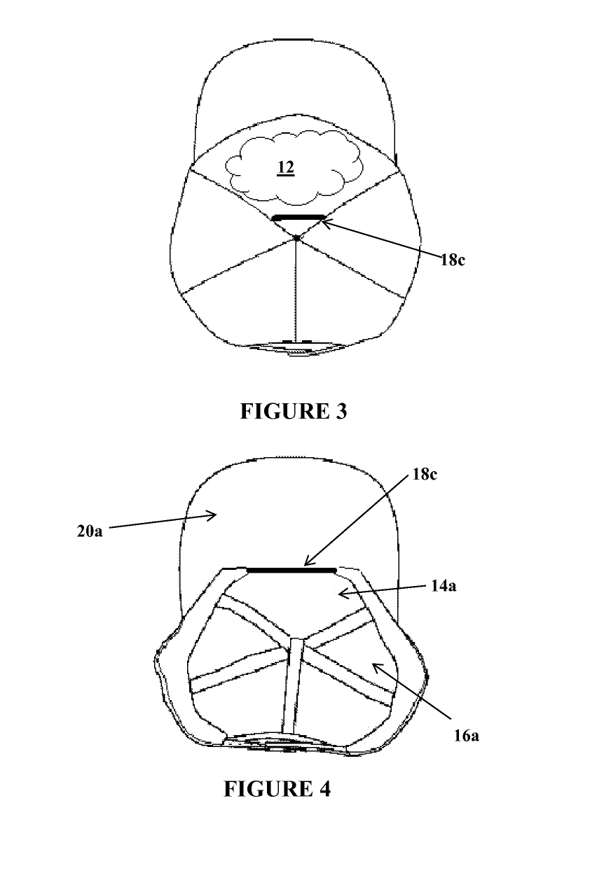

Referring now to FIGS. 3 and 4, an electrical power source (not shown) which may be by way of example a thin film polymer rechargeable battery (not shown) is also located within the integrated housing 12a for supplying electrical power to the miniaturized foled video screen 12 while also proving a power source for the software/memory module included within the integrated housing 12a. The USB connector which is part of the integrated housing 12a also provides a charge port for recharging the rechargeable battery (not shown). In use, the wearer after uploading through the USB port 18a selects their digital representations 18c of choice to be shown on the miniaturized foled video screen 12 by pressing the buttons 18b located on the integrated housing 12a while wearing the cap 16 for viewing by third parties (not shown).

Additionally, one of the buttons located on the front of integrated housing 12a will provide means for both turning on and off the foled display cap of the present invention. Turning once again to FIGS. 3 and 4 it is shown that the integrated housing 12a is affixed to both the exterior front 14 and interior back 14a thereby defining an exterior inside portion 16a of cap 16. It may be envisioned that the cap be made of any flexible wearable and breathable materials such as cloth or vinyl and the like wherein the integrated housing may be made of any suitable plastic material. Lastly, it should be noted that the integrated housing is manufactured such that it is environmentally safe and hazardous free when worn.

In summary, there is disclosed a foled display cap which will store and display digital images and/or video using a flexible organic light emitting diode (FOLED) display panel as a monitor on the front of the cap. An electronic component portion is provided containing buttons to browse content as well as a built in rechargeable battery which is compatible with a USB adapter. The FOLED display will support both still and looping images as well as video playback.

Although particular embodiments of the invention have been shown and described in full here, there is no intention to thereby limit the invention to the details of such embodiments. On the contrary, the intention is to cover all modifications, alternatives, embodiments, usages and equivalents of the subject invention as fall within the spirit and scope of the invention, specification, and the appended claims.

What is claimed is:

1. A display cap comprising:
an integrated housing for attaching and operating a miniaturized flexible organic light emitting diode video screen.

2. The display cap according to claim 1 wherein said integrated housing further includes a software module having a memory module and a plurality of buttons for controlling images which are visible on said video screen.

3. The display cap according to claim 1 wherein said plurality of buttons allow for input of digital representations of video, images and text and store said digital representations into said memory module for use by said software module through a USB input port within said integrated housing.

4. The display cap according to claim 1 wherein an electrical power source is located within said integrated housing for supplying electrical power to said miniaturized flexible organic light emitting diode video screen and software/memory module.

5. The display cap according to claim 1 wherein a battery is located within said integrated housing for supplying electrical power to said miniaturized flexible organic light emitting diode video screen and software/memory module while also providing a means for recharging said battery.

6. The display cap according to claim 1 wherein a thin film polymer rechargeable battery is located within said integrated housing for supplying electrical power to said miniaturized flexible organic light emitting diode video screen and software/memory module while also providing a means for recharging said battery.

7. The display cap according to claim 1 wherein a wearer then selects their digital representations of choice to be shown on said miniaturized flexible organic light emitting diode video screen by pressing said buttons located on said integrated housing while wearing the cap for viewing by third parties.
